(19) United States
(12) Patent Application Publication
(10) Pub. No.: US 2019/0028537 A1
(43) Pub. Date: Jan. 24, 2019

(54) METHOD AND SYSTEM FOR DYNAMICALLY HANDLING LOAD ON A COMPUTER NETWORK

(71) Applicant: WIPRO LIMITED, BANGALORE (IN)

(72) Inventor: Radha KRISHNA SINGURU, HYDERABAD (IN)

(73) Assignee: Wipro Limited

(21) Appl. No.: 15/690,495

(22) Filed: Aug. 30, 2017

(30) Foreign Application Priority Data
Jul. 18, 2017 (IN) 201741025510

(51) Int. Cl. H04L 29/08; H04L 12/24

(52) U.S. Cl. CPC H04L 67/1008; H04L 41/16; H04L 41/142; H04L 41/147

(57) ABSTRACT

This disclosure relates to method and system for dynamically handling load on a computer network. In one embodiment, the method includes forecasting recurring load patterns based on a statistical analysis of ongoing network traffic transaction data and historical network traffic transaction data for the computer network, learning a relationship between a peak traffic level and the network traffic transaction data based on an analysis of the historical network traffic transaction data, estimating a current peak traffic level for the ongoing network traffic transaction data based on the relationship, and predicting the upcoming load congestion level by correlating the recurring load patterns and the current peak traffic level. The network traffic transaction data includes at least a network packet parameter, a domain parameter, and a location parameter. The method further includes dynamically handling the upcoming load congestion level by directing an upcoming network traffic to appropriate service instances.

### TECHNICAL FIELD

This disclosure relates generally to computer networks, and more particularly to method and system for dynamically handling load on a computer network.

### BACKGROUND

Computer networking has become an integral part of conducting business in today's world. It may be vital that the computer network operate efficiently so as to truly harness its benefits. Therefore, companies whose websites get a great amount of traffic typically employ a load balancer for efficiently and effectively distributing network or application traffic across a number of servers, failing which they may face server downtime, traffic disruptions, traffic loss (packet drops), and unhappy user experience. Thus, the load balancer may increase capacity and improve the overall performance of applications.

The load balancer may employ one or more of various logic such as round-robin logic (i.e., distributing incoming traffic to pre-defined servers in round-robin fashion), least connections (i.e., distributing incoming traffic to a server having least connections), least response time (i.e., distributing incoming traffic to a server that will take least time to respond), or some other user-configured logic. However, existing implementations based on pre-configured algorithms are static in nature and not adaptable to dynamic network traffic conditions. Thus, the existing techniques cannot dynamically detect and adapt to any change in traffic patterns, which may result in undesirable traffic disruptions or traffic loss. Some of the existing techniques provide for predicting packet transaction patterns so as to dynamically scale-up and scale-down the required services. However, these techniques does not accurately and reliably predict network load congestion level.

### SUMMARY

In one embodiment, a method for predicting an upcoming load congestion level on a computer network, and for dynamically handling the upcoming load congestion level is disclosed. In one example, the method may include forecasting one or more recurring load patterns based on a statistical analysis of ongoing network traffic transaction data and historical network traffic transaction data for the computer network. The network traffic transaction data may include at least a network packet parameter, a domain parameter, and a location parameter. The method may further include learning a relationship between a peak traffic level and the network traffic transaction data based on an analysis of the historical network traffic transaction data. The method may further include estimating a current peak traffic level for the ongoing network traffic transaction data based on the relationship. The method may further include predicting the upcoming load congestion level by correlating the one or more recurring load patterns and the current peak traffic level. The method may further include dynamically handling the upcoming load congestion level by directing an upcoming network traffic to one or more appropriate service instances.

In one embodiment, a system for predicting an upcoming load congestion level on a computer network, and for dynamically handling the upcoming load congestion level is disclosed. In one example, the system may include a network device including at least one processor and a memory communicatively coupled to the at least one processor. The memory may store processor-executable instructions, which, on execution, may cause the processor to forecast one or more recurring load patterns based on a statistical analysis of ongoing network traffic transaction data and historical network traffic transaction data for the computer network. The network traffic transaction data may include at least a network packet parameter, a domain parameter, and a location parameter. The processor-executable instructions, on execution, may further cause the processor to learn a relationship between a peak traffic level and the network traffic transaction data based on an analysis of the historical network traffic transaction data. The processor-executable instructions, on execution, may further cause the processor to estimate a current peak traffic level for the ongoing network traffic transaction data based on the relationship. The processor-executable instructions, on execution, may further cause the processor to predict the upcoming load congestion level by correlating the one or more recurring load patterns and the current peak traffic level. The processor-executable instructions, on execution, may further cause the processor to dynamically handle the upcoming load congestion level by directing an upcoming network traffic to one or more appropriate service instances.

In one embodiment, a non-transitory computer-readable medium storing computer-executable instructions for predicting an upcoming load congestion level on a computer network, and for dynamically handling the upcoming load congestion level is disclosed. In one example, the stored instructions, when executed by a processor, may cause the processor to perform operations including forecasting one or more recurring load patterns based on a statistical analysis of ongoing network traffic transaction data and historical network traffic transaction data for the computer network. The network traffic transaction data may include at least a network packet parameter, a domain parameter, and a location parameter. The operations may further include learning a relationship between a peak traffic level and the network traffic transaction data based on an analysis of the historical network traffic transaction data. The operations may further include estimating a current peak traffic level for the ongoing network traffic transaction data based on the relationship. The operations may further include predicting the upcoming load congestion level by correlating the one or more recurring load patterns and the current peak traffic level. The operations may further include dynamically handling the upcoming load congestion level by directing an upcoming network traffic to one or more appropriate service instances.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for predicting and dynamically handling an upcoming load congestion level on a computer network in accordance with some embodiments of the present disclosure.

FIG. 2 is a functional block diagram of a load prediction and handling engine in accordance with some embodiments of the present disclosure.

FIG. 3 is a flow diagram of an exemplary process for predicting and dynamically handling an upcoming load congestion level on a computer network in accordance with some embodiments of the present disclosure.

FIG. 4 is a flow diagram of a detailed exemplary process for predicting and dynamically handling an upcoming load congestion level on a computer network in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

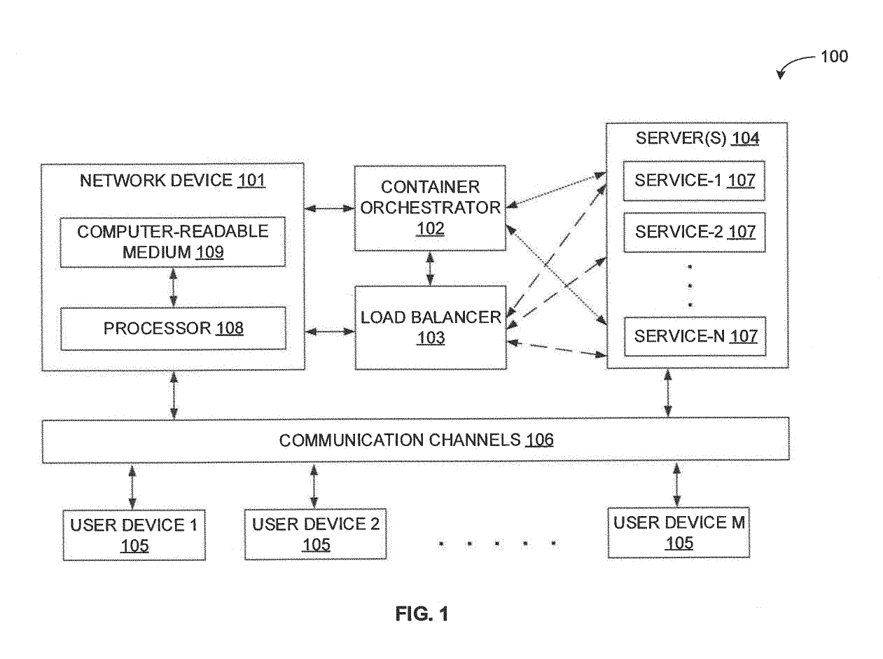

Referring now to FIG. 1, an exemplary system 100 for predicting and dynamically handling an upcoming load congestion level on a computer network is illustrated in accordance with some embodiments of the present disclosure. In particular, the system 100 may include a network device 101, a container orchestrator 102, a load balancer 103, and one or more servers 104. It should be noted that the network device 101, the container orchestrator 102, the load balancer 103, and the one or more servers 104 may be in communication among each other directly or through an intermediary device(s). Further, the system 100 may include one or more user devices 105 (user device 1, user device 2 . . . user device M) adapted to access the one of more servers 104 over a wired or a wireless communication channel(s) 106. It should be noted that each of the user devices 105 may receive service request from a corresponding user. The user device 105 may then connect to the server 104 via the network device 101 to execute the service request. The network device 101 in conjunction with the container orchestrator 102 and the load balancer 103 may direct the service request to appropriate container or service instance(s) 107 (service-1, service-2 . . . service-N) in the one or more server 104 for servicing the service request. As will be appreciated by those skilled in the art, each of the components 101-105 of the system 100 may be a processor based computing device capable of being part of the computer network (i.e., a cloud platform). The processor based computing device may include, but is not limited to, a computer, a laptop, a personal computing device (e.g., a tablet computer, a smartphone, etc.), a server, a router, and so forth.

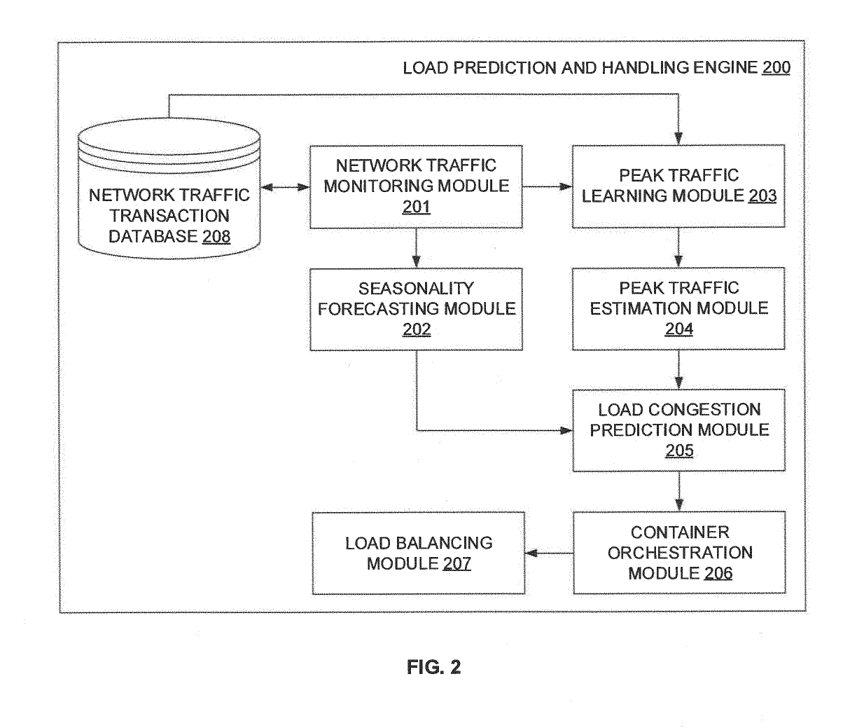

Additionally, the network device 101 either by itself or in conjunction with one or more of the container orchestrator 102, the load balancer 103, and the server 104 may implement a load prediction and handling engine for predicting and dynamically handling the upcoming load congestion level on the computer network in accordance with some embodiments of the present disclosure. As will be described in greater detail in conjunction with FIG. 2, the load prediction and handling engine may forecast one or more recurring load patterns based on a statistical analysis of ongoing network traffic transaction data and historical network traffic transaction data for the computer network, learn a relationship between a peak traffic level and the network traffic transaction data based on an analysis of the historical network traffic transaction data, estimate a current peak traffic level for the ongoing network traffic transaction data based on the relationship, and predict the upcoming load congestion level by correlating the one or more recurring load patterns and the current peak traffic level. Further, the load prediction and handling engine may dynamically handle the upcoming load congestion level by directing an upcoming network traffic to one or more appropriate service instances.

Thus, the network device 101 may detect seasonality (i.e., peak traffic level). The network device 101 may then predict when there will be peak traffic (for example, on a Friday evening) and therefore dynamically anticipate the upcoming congestion level. The network device 101 may then instruct the container orchestrator 102 and program the load balancer 103 accordingly. For example, the network device 101 may instruct the container orchestrator 102 to create additional service instances 107 (for an increase in the upcoming load congestion level) or remove some of existing service instances 107 (for a decrease in the upcoming load congestion level) using preconfigured images. Further, the network device 101 may program the load balancer 103 to take proactive measures to direct the traffic (i.e., service requests) to the appropriate service instances 107. The dynamic creation and deployment of additional service instances 107 may effectively help in handling increased network load without network traffic loss (i.e., without dropping packets).

The network device 101 may include one or more processors 108 and a computer-readable medium (e.g., a memory) 109. The computer-readable medium 109 may store instructions that, when executed by the one or more processors 108, cause the one or more processors 108 to predict and dynamically handle the upcoming load congestion level on the computer network in accordance with aspects of the present disclosure. The computer-readable storage medium 109 may also store any data as required or as processed by the network device 101 or the system 100. The one or more processors 108 may perform data processing functions so as to forecast recurring load patterns, learn relationships, estimate peak traffic level, predict the upcoming load congestion level, dynamically handle the upcoming load congestion level, and so forth.

As will be appreciated, in some embodiments, the network device 101 may be located locally with respect to the container orchestrator 102, load balancer 102, or the server 104. For example, in some embodiments, the network device 101 may be a separate device in communication with the container orchestrator 102 and the load balancer 102, which in turn are in communication with the server 104. Alternatively, in some embodiments, the network device 101 may be embedded within the container orchestrator 102 or the load balancer 103. Additionally, in some embodiments, the network device 102, the container orchestrator 102, and the load balancer 103 may all be part of the server 104. Further, as will be appreciated, in some embodiments, the network device 101 may be located remotely with respect to the container orchestrator 102, load balancer 102, or the server 104. For example, in some embodiments, the network device 101 may be located in a remote server of a service provider. Further, as will be appreciated, in some embodiments, various components of the network device 101 may be physically located together in one device. Alternatively, in some embodiments, the components of the network device 101 may be physically distributed across various devices. For example, the processor 108 and the computer readable medium 109 may be physically located together in one device or may be physically distributed across various devices.

Referring now to FIG. 2, a functional block diagram of the load prediction and handling engine 200, implemented by the network device 101 of the system 100 of FIG. 1, is illustrated in accordance with some embodiments of the present disclosure. In some embodiments, the load prediction and handling engine 200 may include a network traffic monitoring module 201, a seasonality forecasting module 202, a peak traffic learning module 203, a peak traffic estimation module 204, a load congestion prediction module 205, a container orchestration module 206, a load balancing module 207, and a network traffic transaction database 208. As will be appreciated by those skilled in the art, each of the modules 201-207 and the network traffic transaction database 208 may reside, in whole or in parts, on any of the network device 101, the container orchestrator 102, the load balancer 103, and/or the server 104.

The network traffic monitoring module 201 may acquire ongoing network traffic transaction data of the computer network. The network traffic monitoring module 201 may further store the ongoing network traffic transaction data in the network traffic transaction database 208. As will be appreciated, the network traffic transaction database 208 may also have historical network traffic transaction data of the computer network (i.e., past network traffic transaction data stored by the network traffic monitoring module 201). The network traffic transaction data may include at least a network packet parameter (e.g., rate of incoming packets, packet payload, etc.), a domain parameter (i.e., knowledge with respect to a particular domain such as banking, retail, etc.), and a location parameter (e.g., knowledge with respect to a particular locality such as India, the United States of America, etc.).

The seasonality forecasting module 202 may forecast recurring load patterns (or seasonal patterns) based on the statistical analysis of the ongoing network traffic transaction data and the historical network traffic transaction data. In some embodiments, the seasonality forecasting module 202 may forecast recurring load patterns based on the statistical analysis of the ongoing network packet parameter and the historical network packet parameter. In some embodiments, the recurring load patterns or the seasonal patterns may be a characteristic of a time series in which the network traffic transaction data experiences regular and predictable changes that recur or repeats over a period. Thus, the seasonality forecasting module 202 may perform time series analysis of the network traffic transaction data to determine rate of incoming packets at various time periods. The time series analysis may provide a normal or regular network traffic of the computer network (say, R) during a normal period, as well as outlier network traffic of the computer network (say, 25 times R) during a specific time-period or a season (e.g., end of financial year, during tax filing period, during salary credit period, during college admissions, during festive season etc.). As will be appreciated, there may be various network traffic classification techniques to detect recurrence or seasonality of the network traffic. For example, a simple but an efficient technique may be to employ packet arrival rate.

The peak traffic learning module 203 may learn the relationship existing between a peak traffic level and the network traffic transaction data (i.e., domain parameters, location parameters and network packet parameters) by analyzing the historical network traffic transaction data. Additionally, in some embodiments, peak traffic learning module 203 may further learn the relationship existing between a peak traffic level, domain parameters, location parameters and network packet parameters by analyzing training data. The training data may include pre-defined or user-defined labels or attributes on the domain parameters, the location parameters, the network packet parameters, and the peak traffic level. The attributes may include, but are not limited to, packet arrival rate, day of a week, end of a month, financial year end, onset of monsoon, festive season etc. The peak traffic learning module 203 may employ an artificial intelligence or a machine learning algorithm to learn the relationship. For example, the machine learning algorithm may be trained to detect the peak traffic level from the historical network traffic transaction data. The trained machine learning algorithm may then facilitate in estimation of peak traffic (for example, on a Friday evening) for the ongoing network traffic transaction data, and dynamic prediction of the upcoming load congestion level.

The peak traffic estimation module 204 may estimate a current peak traffic level for the ongoing network traffic transaction data based on the relationship learnt by the peak traffic learning module 203. For example, the peak traffic estimation module 204 may estimate a current peak traffic level for the ongoing network traffic transaction data using the machine learning model derived by the peak traffic learning module 203. In some embodiments, the peak traffic estimation module 204 may estimate the current peak traffic level for the ongoing location parameter and domain parameter based on the learned relationship (i.e., by using the machine learning model). Thus, the peak traffic estimation module 204 may detect normal network traffic and the outlier network traffic.

The load congestion prediction module 205 may predict the upcoming load congestion level by correlating the recurring load patterns (or seasonal patterns) forecasted by the seasonality forecasting module 202 and the current peak traffic level estimated by the peak traffic estimation module 204. In some embodiments, whenever a recurring load pattern is forecasted or identified, it may be qualified as a potential seasonality traffic and the load congestion prediction module 205 may then evaluate accuracy of the forecasted recurring load pattern using the domain parameter and the location parameter. As stated above, the domain parameter may be knowledge with respect to a particular domain such as banking, retail, and so forth. For example, there may be substantially higher traffic to the banking application for cash transactions at the beginning of a month when the salaries are credited. Additionally, for example, there may be substantially higher traffic to the income tax related applications at the end of the financial year. Further, for example, there may be surge in the traffic to the patient care related applications at the onset of monsoons when there may be an outburst of viral related seasonal infections. Moreover, for example, there may be surge in the traffic to the e-commerce sites during festival seasons or during promotional campaigns. Similarly, as stated above, the locality parameter may be knowledge with respect to a particular locality such as India, the United States of America, and so forth. For example, there may be substantially higher traffic to the e-commerce sites during festive season such as Diwali, Dussarah, Ramzan in India. Additionally, for example, there may be substantially higher traffic to the e-commerce sites during festive season such as Thanks Giving, Christmas, New Year in the United States of America.

The container orchestration module 206 may instruct the container orchestrator 102 to proactively create additional service instances using pre-configured images so as to facilitate handling of a predicted increase in the upcoming load congestion level. As will be appreciated, an image may package the application code and the environment required by the application to run. Thus, the service images may be the container images that may be used to start service instances. The service images may be preconfigured with the specific application instance. Further, container orchestration module 206 may instruct the container orchestrator 102 to proactively remove or close some of existing service instances in response to a predicted decrease in the upcoming load congestion level. In other words, the container orchestration module 206 may instruct the container orchestrator 102 to scale-up and scale-down the required services based on the traffic patterns. For example, based on the seasonal load, the container orchestration module 206 may instruct the container orchestrator to dynamically create new service instances using pre-configured service images. Further, the load balancing module 207 may program the load balancer 103 to take proactive measures to direct the traffic to the appropriate container or service instances based on the inputs from the container orchestration module 206. For example, the load balancing module 207 may program the load balancer 103 to divert traffic onto an alternate path (i.e., to additionally created service instances) in response to a predicted increase in the upcoming load congestion level.

As will be appreciated by one skilled in the art, a variety of processes may be employed for predicting and dynamically handling an upcoming load congestion level on a computer network. For example, the exemplary system 100 may predict and dynamically handle the upcoming load congestion level on the computer network by the processes discussed herein. In particular, as will be appreciated by those of ordinary skill in the art, control logic and/or automated routines for performing the techniques and steps described herein may be implemented by the system 100, either by hardware, software, or combinations of hardware and software. For example, suitable code may be accessed and executed by the one or more processors on the system 100 to perform some or all of the techniques described herein. Similarly application specific integrated circuits (ASICs) configured to perform some or all of the processes described herein may be included in the one or more processors on the system 100.

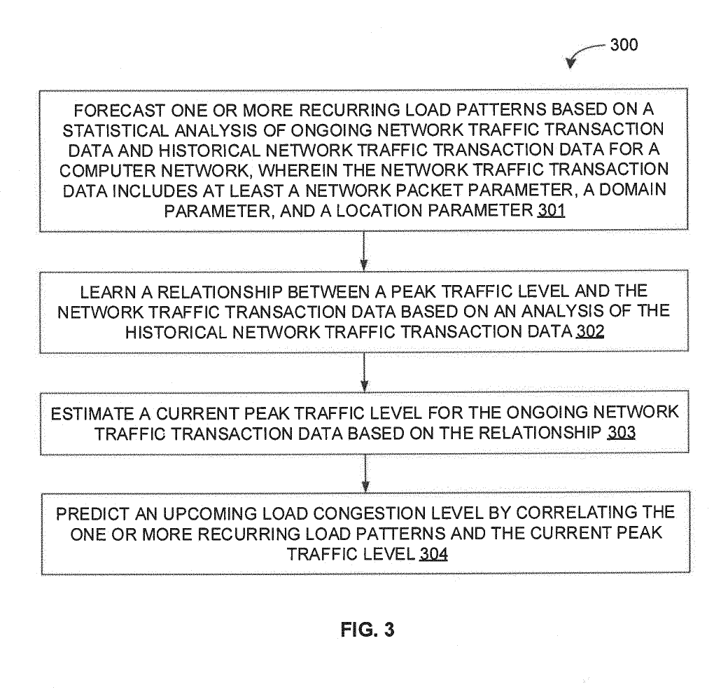

For example, referring now to FIG. 3, exemplary control logic 300 for predicting and dynamically handling an upcoming load congestion level on a computer network via a system, such as system 100, is depicted via a flowchart in accordance with some embodiments of the present disclosure. As illustrated in the flowchart, the control logic 300 may include the steps of forecasting one or more recurring load patterns based on a statistical analysis of ongoing network traffic transaction data and historical network traffic transaction data for the computer network at step 301, learning a relationship between a peak traffic level and the network traffic transaction data based on an analysis of the historical network traffic transaction data at step 302, estimating a current peak traffic level for the ongoing network traffic transaction data based on the relationship at step 303, and predicting the upcoming load congestion level by correlating the one or more recurring load patterns and the current peak traffic level at step 304. The network traffic transaction data may include at least a network packet parameter, a domain parameter, and a location parameter.

In some embodiments, the control logic 300 may further include the step of dynamically handling the upcoming load congestion level by directing an upcoming network traffic to one or more appropriate service instances. In such embodiments, for an increase in the upcoming load congestion level, the control logic 300 may include the step of proactively creating and deploying one or more additional service instances using preconfigured images. Further, in such embodiments, for a decrease in the upcoming load congestion level, the control logic 300 may include the step of proactively removing one or more redundant service instances.

In some embodiments, the control logic 300 may further include the steps of acquiring the ongoing network traffic transaction data from the computer network, and receiving the historical network traffic transaction data from a network traffic transaction database. Additionally, in some embodiments, the control logic 300 may include the step of storing the ongoing network traffic transaction data in the network traffic transaction database.

In some embodiments, forecasting the one or more recurring load patterns at step 301 may include performing time series analysis of the network traffic transaction data to determine rate of incoming packets at one or more time periods. Additionally, in some embodiments, learning the relationship at step 302 may be further based on an analysis of training data. The training data may include one or more pre-defined attributes, or one or more user-defined attributes on the network traffic transaction data and the peak traffic level. Further, in some embodiments, learning the relationship at step 302 may include detecting the peak traffic level using a machine learning process. Moreover, in some embodiments, predicting the upcoming load congestion level at step 304 may include evaluating accuracy of each of the one or more recurring load patterns using the domain parameter and the location parameter.

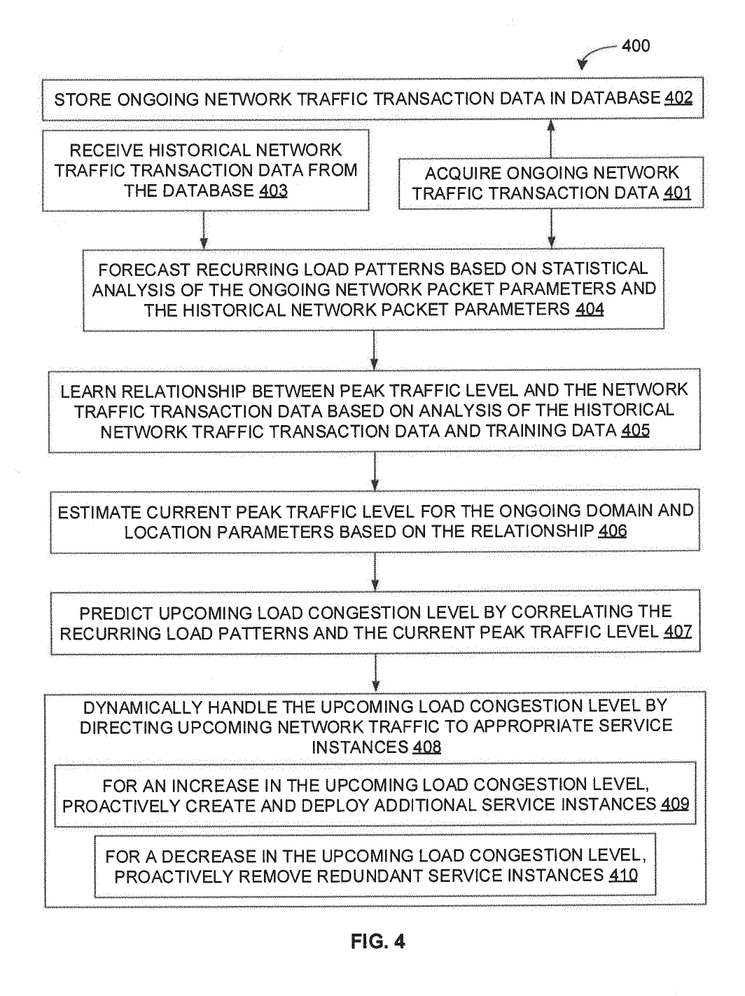

Referring now to FIG. 4, exemplary control logic 400 for predicting and dynamically handling an upcoming load congestion level on a computer network is depicted in greater detail via a flowchart in accordance with some embodiments of the present disclosure. As illustrated in the flowchart, at step 401, the network traffic monitoring module 201 may acquire ongoing network traffic transaction data of the computer network, and may provide the ongoing network traffic transaction data to the seasonality forecasting module 202. At step 402, the network traffic monitoring module 201 may store the ongoing network traffic transaction data in the network traffic transaction database 208. It should be noted that the network traffic transaction database 208 may have historical network traffic transaction data of the computer network (i.e., previously stored network traffic transaction data of the computer network). As described in detail above, the network traffic transaction data may include at least a network packet parameter, a domain parameter, and a location parameter.

At step 403, the seasonality forecasting module 202 may also receive the historical network traffic transaction data of the computer network from the network traffic transaction database 208. At step 404, the seasonality forecasting module 202 may forecast recurring load patterns (or seasonal patterns) based on the statistical analysis of the ongoing network packet parameters and the historical network packet parameters. At step 405, the peak traffic learning module 203 may learn the relationship existing between a peak traffic level and the network traffic transaction data (i.e., domain parameters, location parameters, and network packet parameters) by analyzing the historical network traffic transaction data and training data. The training data may include pre-defined or user-defined attributes on domain parameters, location parameters, network packet parameters, and peak traffic levels. At step 406, the peak traffic estimation module 204 may estimate a current peak traffic level for the ongoing network traffic transaction data (i.e., domain parameters and location parameters) based on the learnt relationship. At step 407, the load congestion prediction module 205 may predict the upcoming load congestion level by correlating the forecasted recurring load patterns (or seasonal patterns) and the estimated current peak traffic level.

At step 408, the container orchestration module 206 in conjunction with the load balancing module 207 may dynamically handle the upcoming load congestion level by directing upcoming network traffic to appropriate service instances. Thus, at step 409, for a predicted increase in the upcoming load congestion level, the container orchestration module 206 may dynamically trigger the container orchestrator for a proactive creation of additional service instances. Further, at step 409, the load balancing module 207 may dynamically program the load balancer for proactive deployment of the additional service instances so as to handle the predicted increase in the upcoming load congestion level. Similarly, at step 410, for a predicted decrease in the upcoming load congestion level, the container orchestration module 206 may dynamically trigger the container orchestrator for a proactive removal or closure of redundant service instances. Further, at step 410, the load balancing module 207 may dynamically program the load balancer for proactive deployment of the remaining service instances so as to handle the predicted decrease in the upcoming load congestion level.

As will be also appreciated, the above described techniques may take the form of computer or controller implemented processes and apparatuses for practicing those processes. The disclosure may also be embodied in the form of computer program code containing instructions embodied in tangible media, such as floppy diskettes, solid state drives, CD-ROMs, hard drives, or any other computer-readable storage medium, wherein, when the computer program code may be loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code may be loaded into and executed by a computer, the computer becomes an apparatus for practicing the invention. When implemented on a general-purpose microprocessor, the computer program code segments configure the microprocessor to create specific logic circuits.

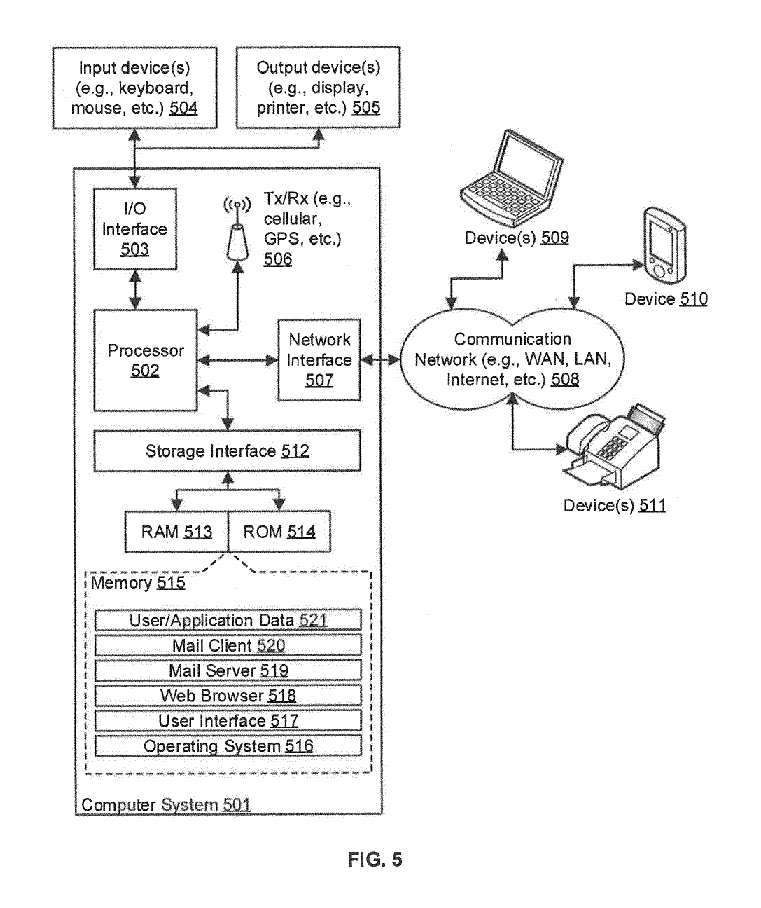

Referring now to FIG. 5, a block diagram of an exemplary computer system 501 for implementing embodiments consistent with the present disclosure is illustrated. Variations of computer system 501 may be used for implementing system 100 for predicting and dynamically handling an upcoming load congestion level on a computer network. Computer system 501 may include a central processing unit (“CPU” or “processor”) 502. Processor 502 may include at least one data processor for executing program components for executing user-generated or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O Interface 503 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink™ WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., ongoing network traffic transaction data, historical network traffic transaction data, training data, learnt relationship or machine learning model, recurring load patterns, current peak traffic level, predicted upcoming load congestion level, pre-configured images, service instances, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above may provide for dynamically handling of load on a computer network in an efficient, effective, and reliable manner. The techniques employ machine learning enabled seasonality detection model to automatically detect changes in traffic patterns. Further, the techniques employ container technology to scale-up and scale-down the required services using preconfigured service images based on the detected traffic patterns. Thus, the techniques integrate machine learning technique with container technology technique so as to proactively and accurately detect and adapt to dynamic traffic pattern changes, and to prevent traffic loss in a timely and cost effective manner.

Further, as will be appreciated by those skilled in the art, the techniques described in the various embodiments discussed above may provide for an improved and an accurate load congestion prediction by applying statistical trending techniques on network packets parameters and machine learning techniques on domain parameters and location parameters, and by combining the two. In other words, the accuracy of load congestion prediction is improved by automatically analyzing the combination of recurring load patterns, network packet parameters, domain parameters and location parameters.

The specification has described system and method for predicting and dynamically handling an upcoming load congestion level on a computer network. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of predicting an upcoming load congestion level on a computer network, the method comprising:
forecasting, by a network device, one or more recurring load patterns based on a statistical analysis of ongoing network traffic transaction data and historical network traffic transaction data for the computer network, wherein the network traffic transaction data comprises at least a network packet parameter, a domain parameter, and a location parameter;
learning, by the network device, a relationship between a peak traffic level and the network traffic transaction data based on an analysis of the historical network traffic transaction data;
estimating, by the network device, a current peak traffic level for the ongoing network traffic transaction data based on the relationship; and
predicting, by the network device, the upcoming load congestion level by correlating the one or more recurring load patterns and the current peak traffic level.

2. The method of claim 1, further comprising:
acquiring the ongoing network traffic transaction data from the computer network; and
receiving the historical network traffic transaction data from a network traffic transaction database.

3. The method of claim 2, further comprising storing the ongoing network traffic transaction data in the network traffic transaction database.

4. The method of claim 1, wherein forecasting the one or more recurring load patterns comprises performing time series analysis of the network traffic transaction data to determine rate of incoming packets at one or more time periods.

5. The method of claim 1, wherein learning the relationship is further based on an analysis of training data, wherein the training data comprises one or more pre-defined attributes, or one or more user-defined attributes on the network traffic transaction data and the peak traffic level.

6. The method of claim 1, wherein learning the relationship comprises detecting the peak traffic level using a machine learning process.

7. The method of claim 1, wherein predicting the upcoming load congestion level comprises evaluating accuracy of each of the one or more recurring load patterns using the domain parameter and the location parameter.

8. The method of claim 1, further comprising dynamically handling the upcoming load congestion level by directing an upcoming network traffic to one or more appropriate service instances.

9. The method of claim 8, further comprising one of:
for an increase in the upcoming load congestion level, proactively creating and deploying one or more additional service instances using preconfigured images; and
for a decrease in the upcoming load congestion level, proactively removing one or more redundant service instances.

10. A system for predicting an upcoming load congestion level on a computer network, the system comprising:
a network device comprising at least one processor and a computer-readable medium storing instructions that, when executed by the at least one processor, cause the at least one processor to perform operations comprising:
forecasting one or more recurring load patterns based on a statistical analysis of ongoing network traffic transaction data and historical network traffic transaction data for the computer network, wherein the network traffic transaction data comprises at least a network packet parameter, a domain parameter, and a location parameter;
learning a relationship between a peak traffic level and the network traffic transaction data based on an analysis of the historical network traffic transaction data;
estimating a current peak traffic level for the ongoing network traffic transaction data based on the relationship; and
predicting the upcoming load congestion level by correlating the one or more recurring load patterns and the current peak traffic level.

11. The system of claim 10, wherein forecasting the one or more recurring load patterns comprises performing time series analysis of the network traffic transaction data to determine rate of incoming packets at one or more time periods.

12. The system of claim 10, wherein learning the relationship is further based on an analysis of training data, wherein the training data comprises one or more pre-defined attributes, or one or more user-defined attributes on the network traffic transaction data and the peak traffic level.

13. The system of claim 10, wherein learning the relationship comprises detecting the peak traffic level using a machine learning process.

14. The system of claim 10, wherein predicting the upcoming load congestion level comprises evaluating accuracy of each of the one or more recurring load patterns using the domain parameter and the location parameter.

15. The system of claim 10, wherein the operations further comprise:
one of proactively creating and deploying one or more additional service instances using preconfigured images for an increase in the upcoming load congestion level, and proactively removing one or more redundant service instances for a decrease in the upcoming load congestion level; and
dynamically handling the upcoming load congestion level by directing an upcoming network traffic to one or more appropriate service instances.

16. A non-transitory computer-readable medium storing computer-executable instructions for:
forecasting one or more recurring load patterns based on a statistical analysis of ongoing network traffic transaction data and historical network traffic transaction data for a computer network, wherein the network traffic transaction data comprises at least a network packet parameter, a domain parameter, and a location parameter;
learning a relationship between a peak traffic level and the network traffic transaction data based on an analysis of the historical network traffic transaction data;
estimating a current peak traffic level for the ongoing network traffic transaction data based on the relationship; and
predicting an upcoming load congestion level on the computer network by correlating the one or more recurring load patterns and the current peak traffic level.

17. The non-transitory computer-readable medium of claim 16, wherein forecasting the one or more recurring load patterns comprises performing time series analysis of the network traffic transaction data to determine rate of incoming packets at one or more time periods.

18. The non-transitory computer-readable medium of claim 16, wherein learning the relationship comprises detecting the peak traffic level using a machine learning process, wherein learning the relationship is further based on an analysis of training data, and wherein the training data comprises one or more pre-defined attributes, or one or more user-defined attributes on the network traffic transaction data and the peak traffic level.

19. The non-transitory computer-readable medium of claim 16, wherein predicting the upcoming load congestion level comprises evaluating accuracy of each of the one or more recurring load patterns using the domain parameter and the location parameter.

20. The non-transitory computer-readable medium of claim 16, further storing computer-executable instructions for:
one of proactively creating and deploying one or more additional service instances using preconfigured images for an increase in the upcoming load congestion level, and proactively removing one or more redundant service instances for a decrease in the upcoming load congestion level; and
dynamically handling the upcoming load congestion level by directing an upcoming network traffic to one or more appropriate service instances.
